(19) United States
(12) Patent Application Publication
(10) Pub. No.: US 2007/0033768 A1
(43) Pub. Date: Feb. 15, 2007

(54) Door closer

(75) Inventor: Lothar Ginzel, Schwerte (DE)

Correspondence Address: COHEN, PONTANI, LIEBERMAN & PAVANE, 551 FIFTH AVENUE, SUITE 1210, NEW YORK, NY, 10176, US

(73) Assignee: DORMA GMBH + CO. KG, Ennepetal (DE)

(21) Appl. No.: 10/555,192

(22) PCT Filed: Nov. 29, 2004
(86) PCT No.: PCT/EP04/13515

§ 371 Date: Nov. 1, 2005

(30) Foreign Application Priority Data
Jan. 16, 2004 (DE) 10 2004 002 625.4

(51) Int. Cl. E05F 1/00

(52) U.S. Cl. 16/71

(57) ABSTRACT

A door closer with a housing, a brake piston mounted in the housing and operable to axially move therein in response to an external force, a shaft mounted in the housing and coupled to the brake piston so as to rotate in the housing while opening or closing a door, and a locking element provided with a spring which biases the locking element towards the shaft so as to lock the shaft in at least one angular position thereof.

The invention pertains to a door closer with a housing, in which a shaft to be connected to a door or the like is supported, where the shaft, when in at least one position, can be arrested by a spring-loaded locking element.

Doors closers of this type are well known. These door closers normally have a housing, in which a shaft, which can be connected to a door or the like, a spring-loaded locking element, and a brake piston are installed. The locking element and the brake piston are essentially lined up with each other in a row at opposite ends of the shaft in such a way that that, seen overall, the housing has an elongated form. It is often difficult, however, to find the room needed to install a housing form of this type, and it is especially difficult if not impossible to provide a long opening for the housing in the area of the floor. A door closer of this type can be derived from DE 40 38 720 C2, which describes a top-mounted door closer, whereas DE 27 55 787 A1 describes a floor-mounted door closer.

It is therefore the task of the present invention to design a door closer which has a more compact housing and which can thus be accommodated more easily, especially in the floor, and which is also suitable for rebated doors.

This task is accomplished with a door closer of the type explained above in that the spring which acts on the locking element projects at a right angle from the housing.

On the basis of this design, an inventive door closer acquires an essentially L-shaped form, which can still be easily installed in tight spaces. This is especially true in the case of rebated doors, where the length of the closer from the closer shaft to the adjacent door frame is reduced to a minimum.

The subclaims describe additional embodiments of the inventive object.

The primary part (the housing) consists of a rectangular body, to which a tube is permanently connected at a right angle to the axis of the housing. An additional short tube with a bottom piece, to which the bracket carrying the roller is attached, is provided in this first tube with freedom to slide back and forth. The two telescoping tubes have a steel planchet between them. This reduces abrasion and also makes it unnecessary to harden and temper the metal.

According to a preferred elaboration, the spring is supported in a case, preferably tubular, which projects at a right angle from the housing. The case can be connected to the housing in such a way that it can be replaced when desired. This makes it possible not only to fit the elements of the door closer into the smallest possible space but also to attach the sleeve holding the spring adaptively, so that the case can be quickly and easily replaced.

According to another advantageous embodiment, an especially simple design of the locking element consists in a locking element with a cup-like insert, which is supported in the tubular case with freedom to slide back and forth. As a result of this arrangement, the locking element can be guided reliably in the case without fear of jamming.

In another advantageous elaboration, a bracket, which carries a roller cooperating with the shaft, projects into the housing from the bottom of the cup-shaped insert.

So that the shaft connected to the door or the like can be held securely in a certain position, the cup-shaped insert is advantageously spring-loaded toward the housing by a spring held in the sleeve. Thus the locking element will always rest against the shaft no matter what position the shaft may occupy.

So that the cup-shaped insert can always be guided in the sleeve with minimal friction and low wear, a friction-reducing and/or wear-reducing coating or liner, e.g., of steel, as previously described, can, in accordance with a preferred embodiment, be provided between the sleeve and the cup-shaped insert.

To damp the movement of the shaft, an advantageous embodiment provides that a spring-loaded brake piston mounted in the housing acts on the shaft.

To ensure that the brake piston is effectively sealed off against the housing, it is advantageous to provide a seal between the wall of the housing and the brake piston.

So that the door or the like can be held in a defined position, the brake piston, in accordance with a preferred elaboration, can be arrested in a predetermined position by a valve arrangement.

The valve arrangement advantageously has a control valve and a stop valve, which acts on the outflow from the control valve. Thus the outflow of brake fluid can be easily controlled or stopped by the control valve, so that the brake piston is no longer able to move and the door is thus arrested in a certain position.

So that the door or the like can be closed even after it has been arrested, the stop valve, according to an advantageous embodiment, opens automatically when the pressure is increased, and the door will then close under the action of the spring.

To release the arrest of the door, the stop valve can also be actuated electromagnetically.

To ensure nonpositive contact between the brake piston and the shaft, the brake piston, in accordance with a preferred embodiment, is provided with a roller, which interacts with a cam disk mounted on the shaft.

Alternatively, the brake piston can also be connected to the shaft by a rocker and a cam disk. This design offers the advantage of positive guidance, which ensures uniform travel.

Additional features and advantages of the inventive door closer can be derived from the following description of preferred exemplary embodiments:

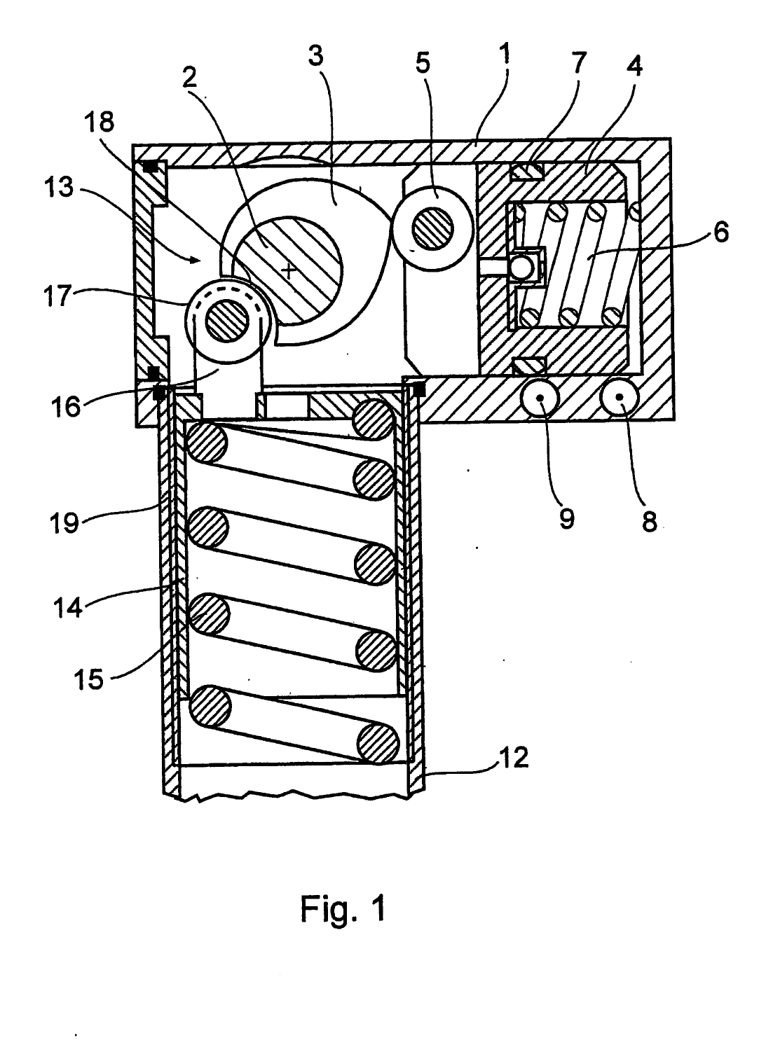

FIG. 1 shows a cross section through the inventive door closer;

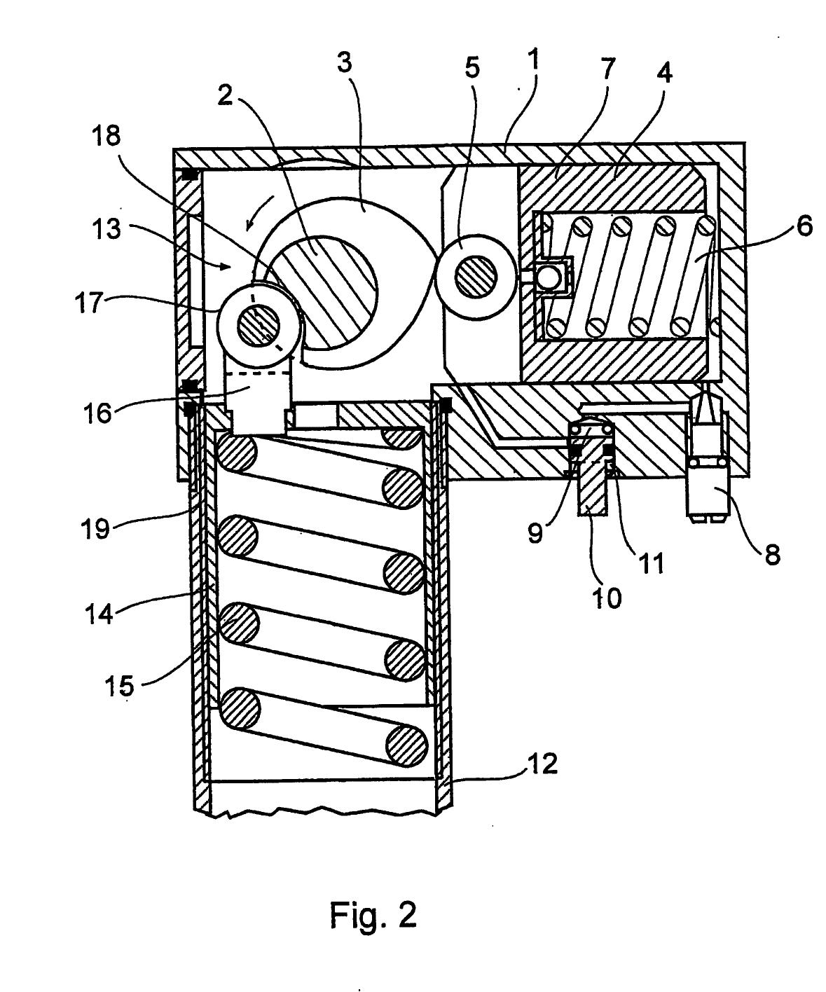

FIG. 2 shows another cross section through the inventive door closer; and

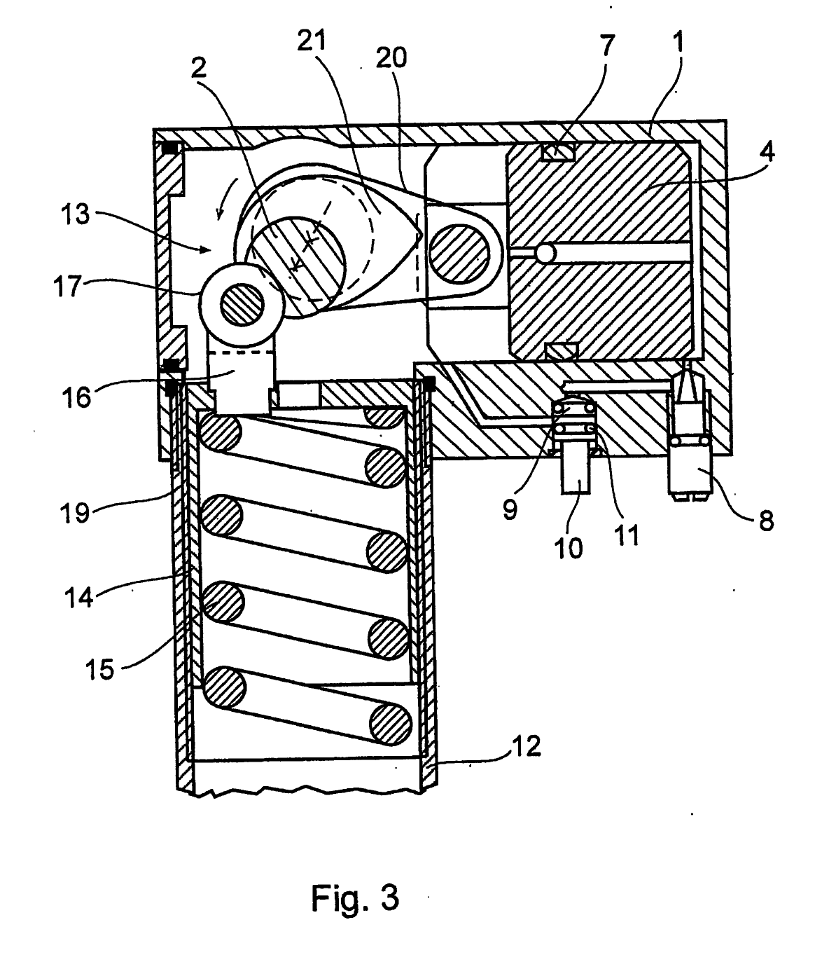

FIG. 3 shows a cross section through another embodiment of the inventive door closer.

In FIGS. 1-3, the inventive door closer is illustrated only to the extent necessary to explain the present invention.

The inventive door closer has an essentially rectangular housing 1, in which a shaft 2, which can be connected to a door or the like, is supported. The shaft 2 has a cam disk 3, which engages with a roller 5, supported on a brake piston 4. The brake piston 4 is supported in turn in the housing 1 with freedom to slide longitudinally back and forth. A spring 6, also supported in the housing 1, pushes the piston toward the shaft 2.

A seal 7 is provided in a circumferential groove in the brake piston 4. This seal is supported against the wall of the housing 1. At the end of the housing 1 remote from the shaft 2 there is a control valve 8, by means of which the movement of the brake piston 4 can be influenced by adjusting the flow of brake fluid in the housing 1. Thus, for example, the door or the like can be arrested in a certain position, such as in the open position.

So that it is still possible to move the door or the like when desired even after it has been arrested, a stop valve 9 is provided, which closes automatically when an intentional effort is made to move the door. For this purpose, it is possible, for example, to provide a small piston 10 or a valve seat. In the position shown, it prevents the escape of brake fluid by the friction of an O-ring 11 against the valve seat, but when the pressure in the brake fluid is increased as a result of an intentional effort to move the door, it shifts position, so that the arresting function is suspended and the door can be moved. In principle, the stop valve 9 could also be actuated electromagnetically, which would also make it possible for the inventive door closer to be used in escape and rescue routes.

A tubular sleeve 12 or case extends at a right angle from the housing 1. This sleeve is mounted detachably on the housing 1, and it holds a locking element 13, which is free to slide back and forth. The locking element 13 has a cup-shaped insert 14, which is supported in the tubular sleeve 12 and which is pushed toward the shaft by a spring 15, also supported in the sleeve 12.

A bracket 16 projects toward the housing 1 from the bottom of the cup-shaped insert 14. At its front end, the bracket carries a roller 17, which, for example, engages in a recess 18 in the shaft 2 and/or in the cam disk 3.

To ensure that the cup-shaped insert 14 can move in the tubular sleeve 12 with the lowest possible friction and least possible wear, a friction-reducing and/or wear-reducing coating or liner 19, e.g., of steel, is provided between the insert 14 and the sleeve 12.

FIG. 3 shows an alternative embodiment of the inventive door closer, in which the brake piston 4 is connected to the shaft 2 by a rocker 20 and a cam disk 21.

The inventive door closer is intended primarily as a floor-mounted door closer, but it can also be installed in other positions.

### LIST OF REFERENCE NUMBERS

1 housing
2 shaft
3 cam disk
4 brake piston
5 roller
6 spring
7 seal
8 control valve
9 stop valve
10 piston
11 O-ring
12 tubular sleeve
13 locking element
14 cup-shaped insert
15 spring
16 bracket
17 roller
18 recess
19 coating or liner
20 rocker
21 cam disk

1-14. (canceled)

15. A door closer comprising:
a housing;
a shaft rotatably mounted in the housing and connectable to a door;
a brake piston mounted along an axis in the housing and operable to act upon the shaft;
a spring-loaded locking element operable to arrest rotation of the shaft in at least one position; and
a spring coupled to the locking element and projecting at a substantially right angle relative to the axis.

16. The door closer of claim 15, further comprising a sleeve detachably coupled to the housing and receiving the spring so as to extend coaxially with the spring.

17. The door closer of claim 16, wherein the sleeve is substantially tubular.

18. The door closer of claim 16, wherein the spring-loaded locking element has a cup-shaped insert extending coaxially with and between the sleeve and the spring, and is operable to reciprocally slide relative to the sleeve.

19. The door closer of claim 18, further comprising a bracket coupled to the cup-shaped insert and extending into the housing, and a roller mounted to the bracket so as to cooperate with the shaft.

20. The door closer of claim 18, wherein the spring is coupled to the cup-shaped insert so as to bias the cup-shaped towards the housing.

21. The door closer of claim 18, further comprising a friction-reducing or wear reducing liner located between the sleeve and the cup-shaped insert.

22. The door closer of claim 15, wherein further comprising a piston spring mounted within the housing so as to urge the brake piston toward the shaft.

23. The door closer of claim 22, further comprising a cam disk mounted on the shaft so that the brake piston acts upon the cam disk.

24. The door closer of claim 15, further comprising a seal between the brake piston and an inner wall of the housing.

25. The door closer of claim 15, further comprising a valve arrangement operable to arrest displacement of the brake piston in a predetermined position.

26. The door closer of claim 25, wherein the valve arrangement comprises a control valve operable to supply flow of working medium to the brake piston, and a stop valve operable to adjust the flow from the control valve.

27. The door closer of claim 26, wherein the stop valve is operable to open automatically in response to an increase in pressure.

28. The door closer of claim 26, wherein the stop valve is electromagnetically actuated.

29. The door closer of claim 15, further comprising a roller coupled to the brake piston, and a cam disk mounted on the shaft so that the roller acts upon the cam disk.

30. The door closer of claim 15, further comprising a rocker arm coupled to the brake piston, a cam disk mounted on the shaft so that the rocker arm acts upon the cam disk
